(19) United States
(12) Patent Application Publication
(10) Pub. No.: US 2022/0029936 A1
(43) Pub. Date: Jan. 27, 2022

(54) PACKET TRANSMISSION DEVICE AND PACKET TRANSMISSION METHOD

(71) Applicant: FUJITSU LIMITED, Kawasaki-shi (JP)

(72) Inventors: Shuhei KATO, Yokohama (JP); Hiroshi Okagawa, Kawasaki (JP)

(73) Assignee: FUJITSU LIMITED, Kawasaki-shi (JP)

(21) Appl. No.: 17/335,268

(22) Filed: Jun. 1, 2021

(51) Int. Cl. H04L 12/861; H04L 12/26; H04L 12/24

(52) U.S. Cl. CPC H04L 49/9005; H04L 41/0677; H04L 43/16

(57) ABSTRACT

A packet transmission device includes a memory, and a first processor coupled to the memory and configured to allocate a packet to a free processor in a plurality of second processors, acquire output determination results of determining whether or not a transmission right value of the allocated packet is equal to or larger than an amount of output data, from the second processors, select an output target processor from the second processors, based on the output determination results of each of the second processors, and set the packet allocated to the selected output target processor to output by a first-in first-out manner.

### CROSS-REFERENCE TO RELATED APPLICATION

This application is based upon and claims the benefit of the prior Japanese Patent Application No. 2020-125582, filed on Jul. 22, 2020, the entire contents of which are incorporated herein by reference.

### FIELD

The embodiments discussed herein are related to a packet transmission device and a packet transmission method.

### BACKGROUND

In a packet transmission device of the related art, the que number of a reception destination corresponding to a line identification number of an input packet is specified, and the input packet is accumulated in a queue of the reception destination queue number. Further, the packet transmission device determines that a packet may be output when the value of the transmission right of a queue number is larger than the packet length of the head input packet of the corresponding queue, and outputs the input packet from the corresponding queue.

Further, in the packet transmission device, when the input packet of the queue is output, the packet length of the input packet output from the que is subtracted from the transmission right value of the reception destination queue number, and the value of a period addition is periodically added to the transmission right value for each reception destination queue number to update the transmission right value. This period addition value differs depending on the contract speed of the reception destination queue number.

A scheduler that controls the entire packet transmission device centrally controls each queue, such as updating the transmission right value, for example, for adding the period addition value to the transmission right value for each reception destination queue number and subtracting the packet length from the transmission right value when the input packet is output.

Related technologies are disclosed in, for example, Japanese Laid-Open Patent Publication Nos. 2016-162266 and 2003-188936.

### SUMMARY

According to an aspect of the embodiments, a packet transmission device includes a memory, and a first processor coupled to the memory and configured to allocate a packet to a free processor in a plurality of second processors, acquire output determination results of determining whether or not a transmission right value of the allocated packet is equal to or larger than an amount of output data, from the second processors, select an output target processor from the second processors, based on the output determination results of each of the second processors, and set the packet allocated to the selected output target processor to output by a first-in first-out manner.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a packet transmission device according to a first embodiment;

FIG. 2 is a block diagram illustrating an example of the functional configuration of a packet processing unit;

FIG. 3 is a block diagram illustrating an example of the functional configuration of a distribution control unit;

FIG. 4 is an explanatory diagram illustrating an example of DSP setting information;

FIG. 5 is an explanatory diagram illustrating an example of a packet management table;

FIG. 6 is an explanatory diagram illustrating an example of a DSP-free management table;

FIG. 7 is an explanatory diagram illustrating an example of a DSP allocation management table;

FIG. 8 is an explanatory diagram illustrating an example of a packet allocation management table;

FIG. 9 is an explanatory diagram illustrating an example of a failure management table;

FIG. 10 is an explanatory diagram illustrating an example of an output FIFO;

FIG. 11 is an explanatory diagram illustrating an example of the functional configuration of a managing unit;

FIG. 12 is an explanatory diagram illustrating an example of processing of a DSP for one packet and the managing unit;

FIG. 13 is an explanatory diagram illustrating an example of a bitmap configuration of an output determination value register;

FIG. 14 is a flowchart illustrating an example of the processing operation of a packet processing unit related to a packet reception process;

FIG. 15 is a flowchart illustrating an example of the processing operation of an allocation managing unit related to an input packet process;

FIG. 16 is a flowchart illustrating an example of the processing operation of a DSP related to an output determination process;

FIG. 17 is a flowchart illustrating an example of the processing operation of an output selecting unit related to a first output selection process;

FIG. 18 is a flowchart illustrating an example of the DSP processing operation related to a packet information update process;

FIG. 19 is a flowchart illustrating an example of the processing operation of an output selecting unit related to an output FIFO set process;

FIG. 20 is a flowchart illustrating an example of the processing operation of an allocation managing unit related to a failure monitoring process;

FIG. 21 is an explanatory diagram illustrating an example of a failure management table at the time of DSP failure detection;

FIG. 22 is an explanatory diagram illustrating an example of a bitmap configuration of an output determination value register according to a second embodiment;

FIG. 23 is a flowchart illustrating an example of the processing operation of an output selecting unit related to a second output selection process of the second embodiment;

FIG. 24 is an explanatory diagram illustrating an example of a packet transmission device of a comparative example;

FIG. 25 is an explanatory diagram illustrating an example of the functional configuration of a traffic managing unit;

FIG. 26 is a flowchart illustrating an example of the processing operation of a packet processing unit related to a packet process;

FIG. 27 is a flowchart illustrating an example of the processing operation of a scheduler related to a queue distribution process;

FIG. 28 is a flowchart illustrating an example of the processing operation of a scheduler related to a transmission right value update process;

FIG. 29 is an explanatory diagram illustrating an example of an operation of adding a period addition value of each queue related to a speed limit memory;

FIG. 30 is a flowchart illustrating an example of the processing operation of a scheduler related to a packet output process;

FIG. 31 is a flowchart illustrating an example of the processing operation of a scheduler related to an output queue selection process; and

FIG. 32 is an explanatory diagram illustrating an example of a problem of a packet transmission device related to periodic update of a speed limit memory and retrieval of a queue storage memory.

### DESCRIPTION OF EMBODIMENTS

In recent years, as the 5G services have been used to implement ultra-low latency and multiple simultaneous connections, there is a tendency to increase the number of queues corresponding to packet inputs from multiple connection destinations.

However, in the packet transmission device of the related art, as the number of queues at the connection destination increases, the processing load on the scheduler that centrally controls the queues increases. As a result, the throughput of packet transmission of the packet transmission device may decrease due to the increase in connection destinations.

### Comparative Example

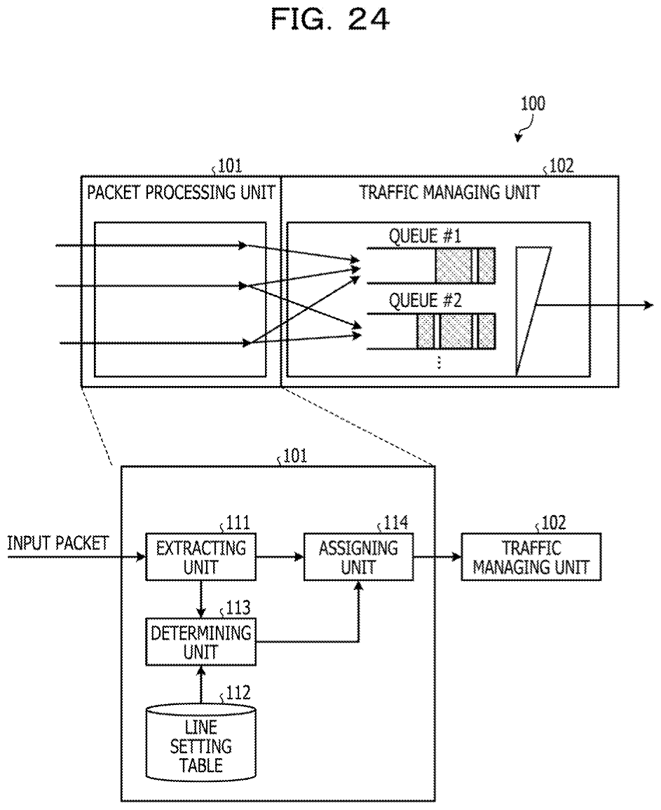

FIG. 24 is an explanatory diagram illustrating an example of a packet transmission device 100 of a comparative example. The packet transmission device 100 illustrated in FIG. 24 includes a packet processing unit 101 and a traffic managing unit 102. The packet processing unit 101 is a processing unit that determines a reception destination queue number of an input packet based on control information in the input packet and user's setting information. The traffic managing unit 102 is a processing unit that accumulates input packets in a queue of the reception destination queue number determined by the packet processing unit 101 and determines a queue number that identifies a queue of the output target that outputs the input packets being accumulated.

The packet processing unit 101 includes an extracting unit 111, a line setting table 112, a determining unit 113, and an assigning unit 114. The extracting unit 111 extracts the control information in the input packet. The control information includes a line identification number (VLANID: Virtual Local Area Network Identifier) and a priority. The line identification number is a line identification number allocated to a contract line. The priority is information that identifies a priority level when an input packet is transmitted. The line setting table 112 is a table that manages the correspondence between a VLANID and a reception destination queue number.

The determining unit 113 refers to the line setting table 112 to determine the que number of a reception destination corresponding to the VLANID in the control information extracted by the extracting unit 111. The assigning unit 114 assigns the determined reception destination queue number to the input packet and outputs the input packet to the traffic managing unit 102.

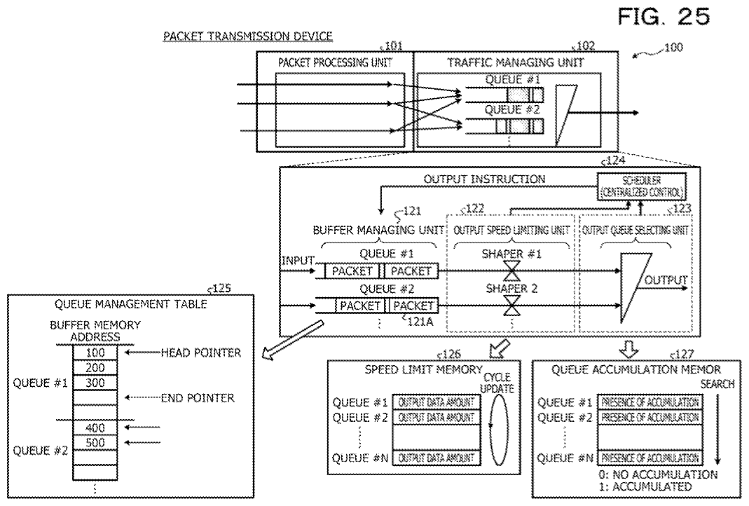

FIG. 25 is an explanatory diagram illustrating an example of the functional configuration of the traffic managing unit 102. The traffic managing unit 102 illustrated in FIG. 25 includes a buffer managing unit 121, an output speed limiting unit 122, an output queue selecting unit 123, a scheduler 124, a queue management table 125, a speed limit memory 126, and a queue storage memory 127.

The buffer managing unit 121 has a buffer memory 121A that accumulates input packets, and manages the buffer memory 121A. The buffer managing unit 121 manages the queues according to the reception destination queue number in the buffer memory 121A. When the input packet is received from the assigning unit 114 in the packet processing unit 101, the buffer managing unit 121 accumulates the input packet in the queue in the buffer memory 121A, according to the reception destination queue number in the input packet. The output speed limiting unit 122 has a shaper for each reception destination queue number and manages the amount of output data (transmission right value) that may be output from each queue according to the reception destination queue number by using the shaper. The output queue selecting unit 123 selects a queue that stores an input packet to be output, from among a plurality of queues for each reception destination queue number.

The scheduler 124 controls the buffer managing unit 121, the output speed limiting unit 122, and the output queue selecting unit 123. The scheduler 124 controls the buffer managing unit 121 that distributes queues to input packets. The scheduler 124 controls the output speed limiting unit 122 that limits the output speed of an input packet for each queue. The scheduler 124 controls the output queue selecting unit 123 that selects an arbitrary queue to be output, which has accumulated packets and does not exceed the upper limit of the output speed, among the plurality of queues. Then, the scheduler 124 controls the output queue selecting unit 123 that reads and outputs the head input packet accumulated in the queue to be output.

The scheduler 124 executes a queue distribution process that distributes queues to input packets. The queue distribution process is a process of extracting a reception destination queue number in an input packet from the assigning unit 114 of the packet processing unit 101 and accumulating the input packet in a queue corresponding to the extracted reception destination queue number. After accumulating the input packet in the queue, the scheduler 124 writes an address of the queue in which the input packet is accumulated, to the queue management table 125. The scheduler 124 sets a storage flag in the queue storage memory 127 corresponding to the queue that accumulates the input packet, from “0” to “1.” The scheduler 124 may refer to the storage flag for each reception destination queue number in the queue storage memory 127 to recognize whether or not the input packet for each reception destination queue number is accumulated.

The scheduler 124 executes a transmission right value update process for updating the contents of the speed limit memory 126 that manages the amount of output data (transmission right value) that may be output by each queue. A period addition value is periodically added to the transmission right value for each queue. The period addition value is the amount of output data to be periodically added according to line setting, that is, the contract speed. Further, when the accumulated packet is output from the queue, the scheduler 124 updates the transmission right value by subtracting the output data amount of the output accumulated packet from the transmission right value of the queue. Therefore, as the number of queues increases, the time for updating all queues increases.

The scheduler 124 refers to the queue storage memory 127 and the speed limit memory 126 to execute an output key selection process for selecting a queue to be output, from a plurality of queues. The output key selection process is a process of selecting a queue in which the storage flag in the queue storage memory 127 is “1” and the transmission right value in the speed limit memory 126 is larger than a packet length.

The scheduler 124 is a packet output process that outputs a packet from a queue of a selected output target. When a packet is output from the queue of the output target and the accumulated packets in the queue are exhausted, the scheduler 124 sets the storage flag corresponding to the corresponding queue in the queue storage memory 127 from “1” to “0.” Further, when the packet is output from the output target queue, the scheduler 124 updates the transmission right value by subtracting the output data amount from the transmission right value corresponding to the corresponding queue in the speed limit memory 126.

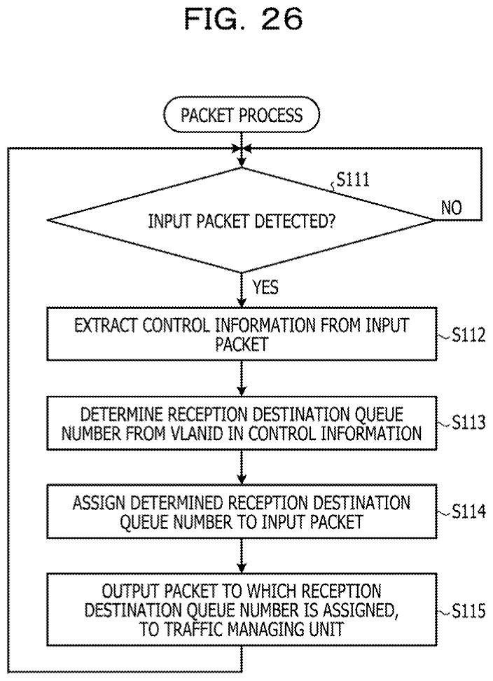

Next, the operation of the packet transmission device 100 of the comparative example will be described. FIG. 26 is a flowchart illustrating an example of the processing operation of the packet processing unit 101 related to the packet process. In FIG. 26, the extracting unit 111 in the packet processing unit 101 determines whether or not an input packet has been detected (operation S111). When it is determined that the input packet has been detected (Yes in operation S111), the extracting unit 111 extracts control information from the input packet (operation S112).

The determining unit 113 in the packet processing unit 101 refers to the line setting table 112 to determine the reception destination queue number corresponding to the VLANID in the extracted control information (operation S113). The assigning unit 114 in the packet processing unit 101 assigns the determined reception destination queue number to the input packet (operation S114). The assigning unit 114 outputs the input packet to which the reception destination queue number is assigned, to the traffic managing unit 102 (operation S115), and ends the processing operation illustrated in FIG. 26. When it is determined that the input packet has not been detected (No in operation S111), the extracting unit 111 ends the processing operation illustrated in FIG. 26.

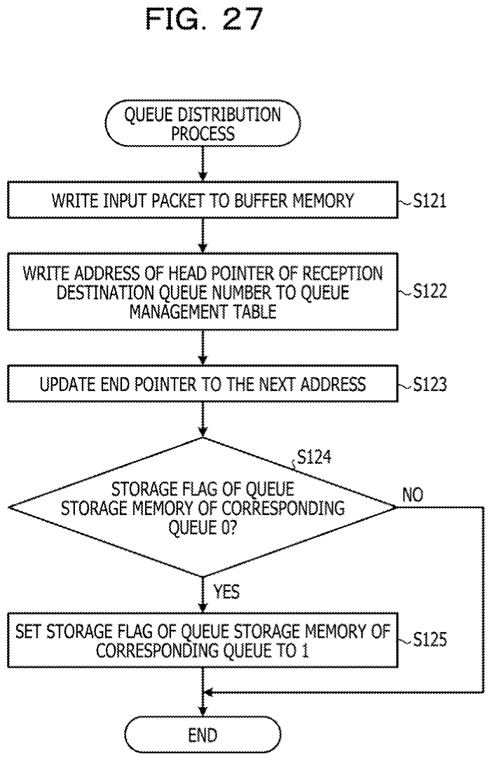

FIG. 27 is a flowchart illustrating an example of the processing operation of the scheduler 124 related to the queue distribution process. In FIG. 27, the scheduler 124 writes to the buffer memory 121A an input packet from the packet processing unit 101 (operation S121). The scheduler 124 writes to the queue management table 125 a storage address, which is the head pointer in the buffer memory 121A, corresponding to the reception destination queue number of the input packet (operation S122). The queue management table 125 manages the storage address of the input packet stored in the buffer memory 121A for each reception destination queue number.

The scheduler 124 updates the end pointer of the corresponding queue number in the queue management table 125 to the next address (operation S123). The scheduler 124 determines whether or not the storage flag of the queue storage memory 127 corresponding to the corresponding queue is “0” (operation S124). When it is determined that the storage flag of the queue storage memory 127 corresponding to the corresponding queue is “0” (Yes in operation S124), the scheduler 124 sets the storage flag of the queue storage memory 127 of the corresponding queue to “1” (operation S125) and ends the processing operation illustrated in FIG. 27. When it is determined that the storage flag of the queue storage memory 127 corresponding to the corresponding queue is not “0” (No in operation S124), the scheduler 124 ends the processing operation illustrated in FIG. 27.

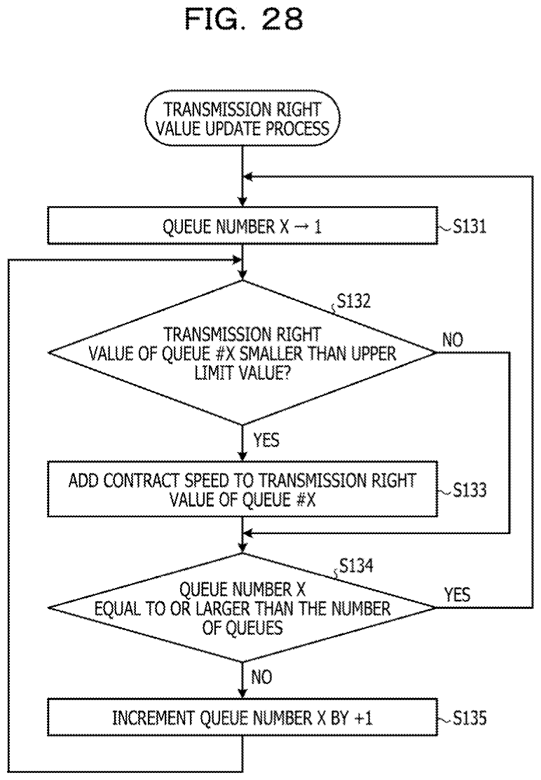

FIG. 28 is a flowchart illustrating an example of the processing operation of the scheduler 124 related to the transmission right value update process. In FIG. 28, the scheduler 124 sets a queue number X to “1” (operation S131). The scheduler 124 determines whether or not the transmission right value corresponding to the queue of the set queue number X is smaller than an upper limit value (operation S132). The upper limit value differs depending on the contract speed.

When it is determined that the transmission right value corresponding to the queue of the set queue number X is smaller than the upper limit value (Yes in operation S132), the scheduler 124 adds a period addition value of the contract speed to the transmission right value corresponding to the queue of the set queue number X (operation S133). The period addition value is the amount of output data to be added for each update cycle of the transmission right value. The contract speed differs depending on the contract contents for each reception destination queue number. The scheduler 124 determines whether or not the set queue number X is equal to or larger than the number of queues N (operation S134). The number of queues N is the number of all queues.

When it is determined that the set queue number X is not equal to or larger than the number of queues N (No in operation S134), the scheduler 124 increments the set queue number X by +1 (operation S135). The scheduler 124 proceeds to operation S132 in order to determine whether or not the transmission right value corresponding to the queue of the set queue number X is smaller than the upper limit value.

When it is determined that the transmission right value corresponding to the queue of the set queue number X is not smaller than the upper limit value (No in operation S132), the scheduler 124 determines that the transmission right value is equal to or larger than the upper limit value, and proceeds to operation S134 in order to determine whether or not the set queue number X is equal to or larger than the number of queues N. When it is determined that the set queue number X is equal to or larger than the number of queues N (Yes in operation S134), the scheduler 124 determines that the update cycle of the transmission right value has been completed by one cycle, and proceeds to operation S131 in order to reset the set queue number X to “1.”

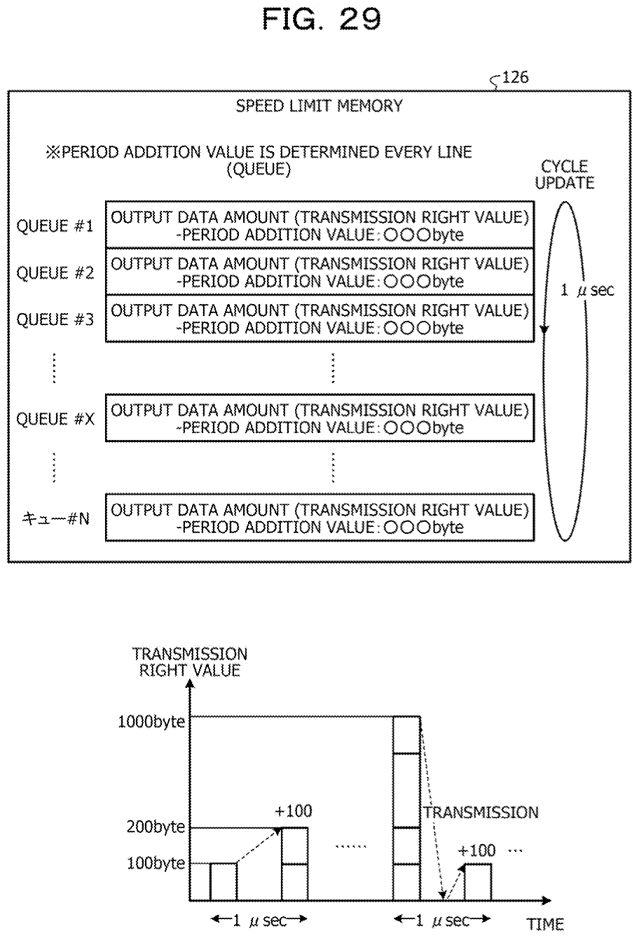

FIG. 29 is an explanatory diagram illustrating an example of an operation of adding the period addition value of each queue related to the speed limit memory 126. For example, focusing on a queue number #X, assume that the contract speed of the line of the queue number #X is 800 Mbps, the update cycle in the speed limit memory 126 is 1 μsec, and the queue state of the queue number #X waits for packet transmission of 1000 bytes. The period addition value is an addition value of the transmission right value to be added for each update cycle of the transmission right value, and is calculated based on the contract speed and the update cycle. That is, the period addition value of the queue number #X is 800 Mbps×1 μsec=800 bits=100 bytes. Therefore, since the period addition value of the queue number #X is 100 bytes, it takes 10 update cycles of 10 μs to reach the transmission right value of 1,000 bytes.

The scheduler 124 compares the transmission right value of the queue number #X with the packet length of the head packet of the corresponding queue, and determines that packet transmission is not possible when the transmission right value is smaller than the packet length of the head packet of the corresponding queue. In the meantime, when the transmission right value is larger than the packet length of the head packet of the corresponding queue, the scheduler 124 determines that packet transmission is possible.

When a packet is output from the corresponding queue, the scheduler 124 updates the transmission right value by subtracting the length of the output packet from the transmission right value of the corresponding queue. For example, in the case of the queue number #X, a 1,000-byte packet is transmitted 10 times in 100-byte units at 1 μsec intervals. That is, 1,000 bytes+10 μsec=100 Mbytes/sec=800 Mbps.

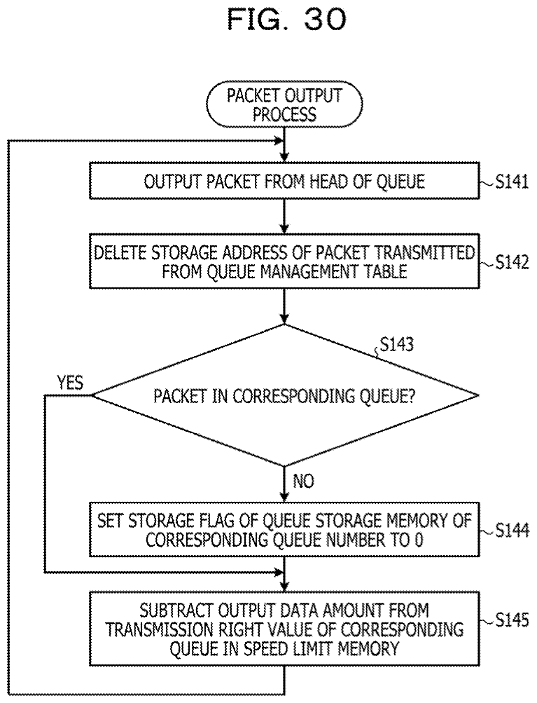

FIG. 30 is a flowchart illustrating an example of the processing operation of the scheduler 124 related to the packet output process. In FIG. 30, when the head packet of the corresponding queue is output (operation S141), the scheduler 124 deletes a storage address of the output packet from the queue management table 125 (operation S142).

The scheduler 124 determines whether or not there is an accumulated packet in the corresponding queue (operation S143). When it is determined that there is no accumulated packet in the corresponding queue (No in operation S143), the scheduler 124 sets the storage flag of the queue storage memory 127 of the corresponding queue number to “0” (operation S144). The scheduler 124 updates the transmission right value by subtracting the amount of output data from the transmission right value of the corresponding queue in the speed limit memory 126 (operation S145), and proceeds to operation S141 in order to output a packet from the head of the corresponding queue.

When it is determined that there is a packet in the corresponding queue (Yes in operation S143), the scheduler 124 proceeds to operation S145 in order to update the transmission right value by subtracting the amount of output data from the transmission right value of the corresponding queue in the speed limit memory 126.

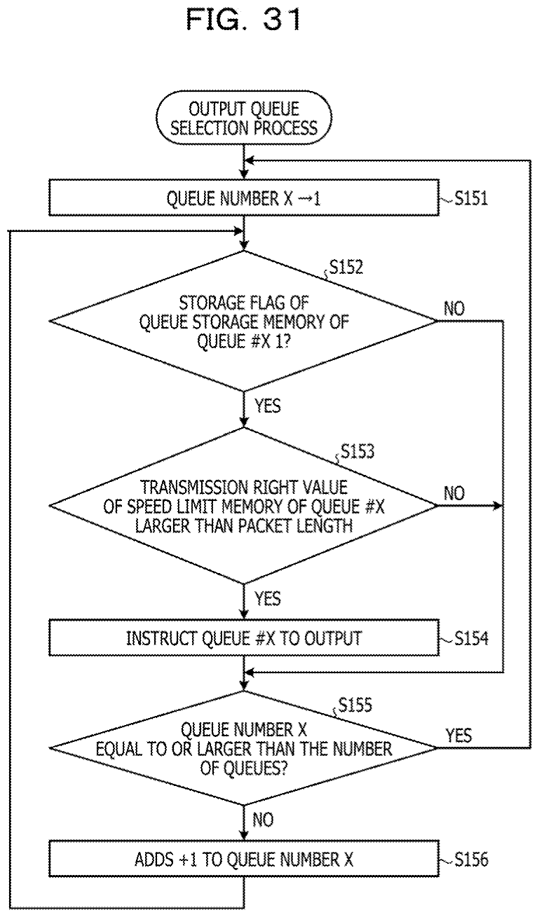

FIG. 31 is a flowchart illustrating an example of the processing operation of the scheduler 124 related to the output queue selection process. In FIG. 31, the scheduler 124 sets the queue number X to “1” (operation S151), and determines whether or not the storage flag of the queue storage memory 127 corresponding to the queue of the set queue number X is “1” (operation S152).

When it is determined that the storage flag of the queue storage memory 127 of the set queue number X is “1” (Yes in operation S152), the scheduler 124 determines whether or not the transmission right value in the speed limit memory 126 of the set queue number X is larger than the packet length (operation S153). When it is determined that the transmission right value of the set queue number X is larger than the packet length (Yes in operation S153), the scheduler 124 instructs the queue of the set queue number X to output (operation S154). Further, the scheduler 124 determines whether or not the set queue number X is equal to or larger than the maximum number of queues N (operation S155).

When it is determined that the set queue number X is not equal to or larger than the maximum number of queues N (No in operation S155), the scheduler 124 adds +1 to the set queue number X (operation S156). Then, the scheduler 124 proceeds to operation S152 in order to determine whether or not the storage flag of the queue storage memory 127 of the set queue number X is “1.”

When it is determined that the storage flag of the queue storage memory 127 of the set queue number X is not “1” (No in operation S152), the scheduler 124 proceeds to operation S155 in order to determine whether or not the set queue number X is equal to or larger than the maximum number of queues N. Further, when it is determined that the transmission right value of the set queue number X is not larger than the packet length (No in operation S153), the scheduler 124 proceeds to operation S155 in order to determine whether or not the set queue number X is equal to or larger than the maximum number of queues N. When it is determined that the set queue number X is equal to or larger than the maximum number of queues N (Yes in operation S155), the scheduler 124 proceeds to operation S151 in order to set “1” to the queue number X.

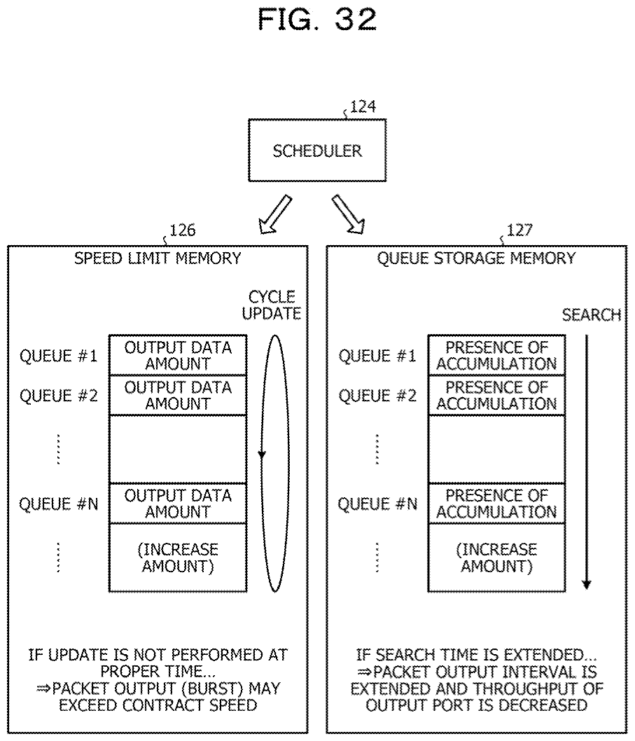

In recent years, 5G services have been used to implement ultra-low latency and multiple simultaneous connections, so there is a tendency to increase the number of queues so as to deal with packet inputs from multiple connection destinations. When the packet transmission device 100 of the comparative example is applied to the 5G service, the number of queues will increase. FIG. 32 is an explanatory diagram illustrating an example of a problem of the packet transmission device 100 related to periodic update of the speed limit memory 126 and retrieval of the queue storage memory 127.

In the speed limit memory 126, when the number of queues increases, since the update cycle becomes long, burst output exceeding the contract speed may occur. Further, even in the queue storage memory 127, when the number of queues increases, since the search time for searching for the accumulation of the storage flag of the queue storage memory 127 for each queue number becomes long, the packet output interval is extended and the packet transmission throughput is decreased. That is, in the packet transmission device 100 of the comparative example, the processing load of the scheduler 124 for updating the period addition value and searching for the storage flag increases as the number of queues increases. As a result, the throughput of packet transmission is decreased due to the increase in connection destinations. Therefore, a packet transmission device 1 of the present embodiment is proposed in order to cope with such a situation.

Hereinafter, embodiments of a packet transmission device and the like capable of coping with the increase in connection destinations will be described in detail based on the drawings. The present disclosure is not limited by each embodiment. In addition, the embodiments described herein below may be appropriately combined with each other in the scope that does not cause any inconsistency.

### First Embodiment

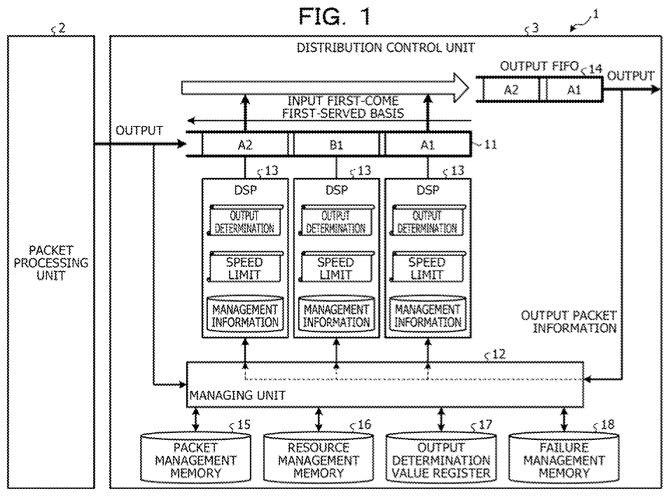

FIG. 1 is an explanatory diagram illustrating an example of a packet transmission device 1 of a first embodiment. The packet transmission device 1 illustrated in FIG. 1 includes a packet processing unit 2 and a distribution control unit 3. The packet processing unit 2 is a processing unit that determines a reception destination queue number of an input packet based on control information in the input packet and user's setting information.

The distribution control unit 3 includes a buffer memory 11, a managing unit 12, a plurality of digital signal processors (DSPs) 13, an output first-in first-out (FIFO) 14, and a packet management memory 15. Further, the distribution control unit 3 includes a resource management memory 16, an output determination value register 17, and a failure management memory 18. The buffer memory 11 is an area for accumulating input packets. The managing unit 12 manages and controls the entire distribution control unit 3. Each DSP 13 is a processing unit that is allocated for each input packet and determines the output of the input packet. The plurality of DSPs 13 is built in a field programmable gate array (FPGA). The output FIFO 14 stores the packet of the output target and outputs it in a first-in first-out manner.

That is, in the packet transmission device 1 of the present embodiment, since each DSP 13 allocated or each input packet distributes and executes the output determination of the input packet, the processing load as in the scheduler 124 that centrally controls all queues in the packet transmission device 100 of the comparative example is eliminated.

The packet management memory 15 is a memory that manages the buffer memory 11. The resource management memory 16 is a memory that manages resources such as the DSPs 13. The output determination value register 17 is a register that manages an output determination value that identifies the presence or absence of output determination of an allocated packet for each DSP 13. The failure management memory 18 is a memory that manages a failure for each DSP 13.

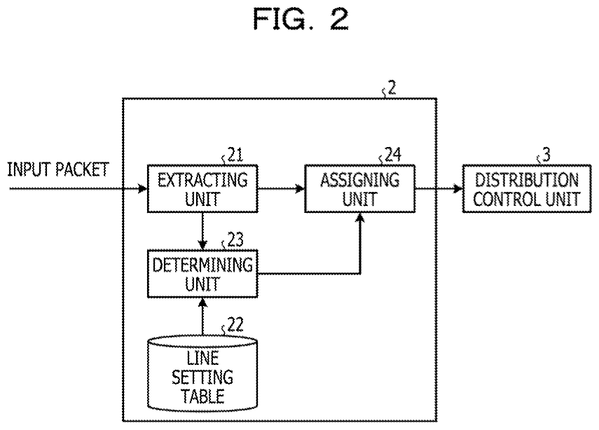

FIG. 2 is a block diagram illustrating an example of the functional configuration of the packet processing unit 2. The packet processing unit 2 illustrated in FIG. 2 includes an extracting unit 21, a line setting table 22, a determining unit 23, and an assigning unit 24. The extracting unit 21 extracts the control information in the input packet. The control information includes a line identification number (VLANID: Virtual Local Area Network Identifier) and a priority of the input packet. The line identification number is a line identification number allocated to the contract line. The priority is information that identifies a priority level when transmitting the input packet. The line setting table 22 is a table that manages the correspondence between the VLANID and a reception destination queue number.

The determining unit 23 refers to the line setting table 22 to determine the reception destination queue number corresponding to the VLANID in the control information extracted by the extracting unit 21. The assigning unit 24 assigns the determined reception destination queue number to the input packet and outputs the input packet to the distribution control unit 3.

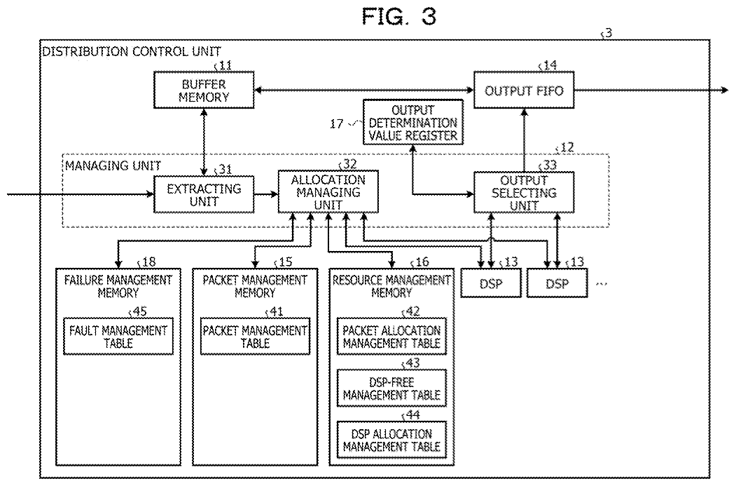

FIG. 3 is a block diagram illustrating an example of the functional configuration of the distribution control unit 3. The managing unit 12 in the distribution control unit 3 illustrated in FIG. 3 includes an extracting unit 31, an allocation managing unit 32, and an output selecting unit 33. The extracting unit 31 extracts the reception destination queue number, a priority, and the like from the input packet. The allocation managing unit 32 controls the entire managing unit 12. The output selecting unit 33 collects the output determination value of each DSP 13.

The packet management memory 15 has a packet management table 41. The packet management table 41 is a table that manages storage addresses in the buffer memory 11 that accumulates the packet, for each packet number that identifies the packet. The packet number is an address number of the buffer memory that accumulates the packet. The resource management memory 16 has a packet allocation management table 42, a free DSP management table 43, and a DSP allocation management table 44. The packet allocation management table 42 is a table that manages a DSP number for each packet number. The free DSP management table 43 is a table that manages a DSP number 13 that identifies a free DSP 13. The DSP allocation management table 44 is a table that manages a packet number for each DSP number. The fault management memory 18 has a fault management table 45. The failure management table 45 is a table that manages a failure for each DSP number.

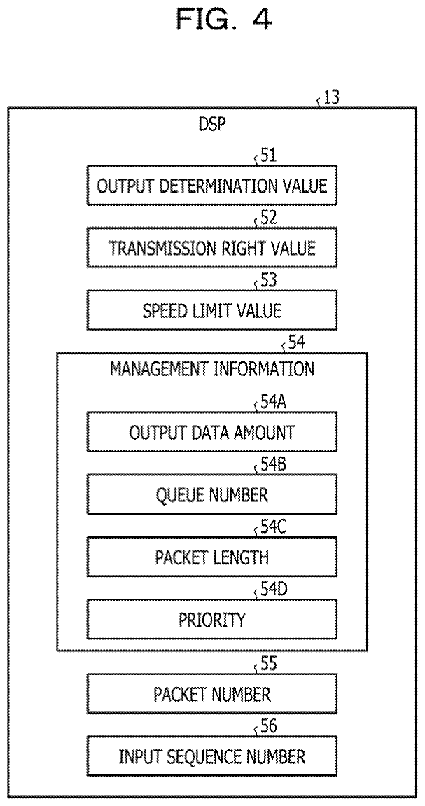

FIG. 4 is an explanatory diagram illustrating an example of setting information of the DSP 13. Each DSP 13 sets the setting information. The setting information includes an output determination value 51, a transmission right value 52, a speed limit value 53, management information 54, a packet number 55, and an input sequence number 56. The output determination value 51 is information that identifies output determination of a packet allocated to the DSP 13. The output determination value 51 is “1” when output is possible, and “0” when output is not possible. The transmission right value 52 is a value used for output determination of the DSP 13. The speed limit value 53 is a period addition value according to the line setting (contract content), which is added for each cycle update. The packet number 55 is information that identifies an allocated packet. The input sequence number 56 is information that identifies an input sequence in which an allocated packet is accumulated in the buffer memory 11.

The management information 54 is information on the allocated packet allocated to the DSP 13. The management information 54 has an output data amount 54A, a queue number 54B, a packet length 54C, and a priority 54D. The output data amount 54A is the amount of output data of the allocated packet. The queue number 54B is the que number of a reception destination assigned to the allocated packet. The packet length 54C is a packet length of the allocated packet. The priority 54D is a priority of the allocated packet.

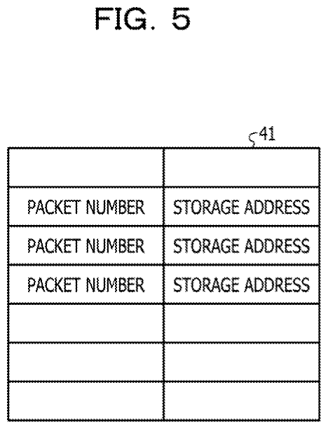

FIG. 5 is an explanatory diagram illustrating an example of the packet management table 41. The packet management table 41 illustrated in FIG. 5 is a table that manages a storage address in the buffer memory 11 that accumulates the packet for each packet number that identifies the packet.

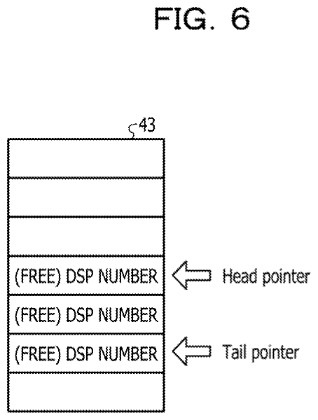

FIG. 6 is an explanatory diagram illustrating an example of the DSP-free management table 43. The DSP-free management table 43 illustrated in FIG. 6 is a table that manages a DSP number that identifies a free DSP 13 that is a packet-unallocated DSP 13.

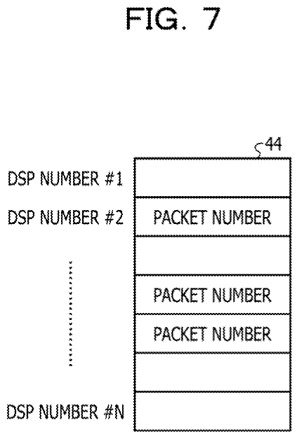

FIG. 7 is an explanatory diagram illustrating an example of the DSP allocation management table 44. The DSP allocation management table 44 illustrated in FIG. 7 is a table that manages a packet number that identifies a packet to be allocated to the DSP 13 for each DSP number that identifies the DSP 13.

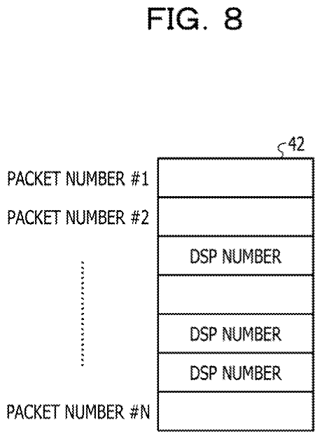

FIG. 8 is an explanatory diagram illustrating an example of the packet allocation management table 42. The packet allocation management table 42 illustrated in FIG. 8 is a table that manages a DSP number that identifies the allocated DSP 13 for each packet number that identifies an allocated packet.

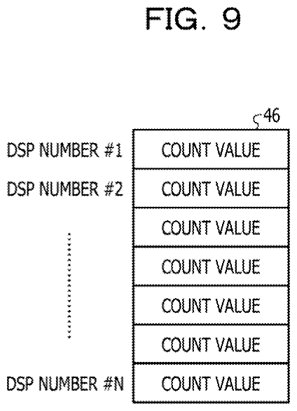

FIG. 9 is an explanatory diagram illustrating an example of the failure management table 45. The failure management table 46 illustrated in FIG. 9 is a table that manages a count value indicating a period during which the DSP 13 holds a packet for each DSP number that identifies the DSP 13, that is, the number of update cycles. The count value is information for determining a failure of the DSP 13.

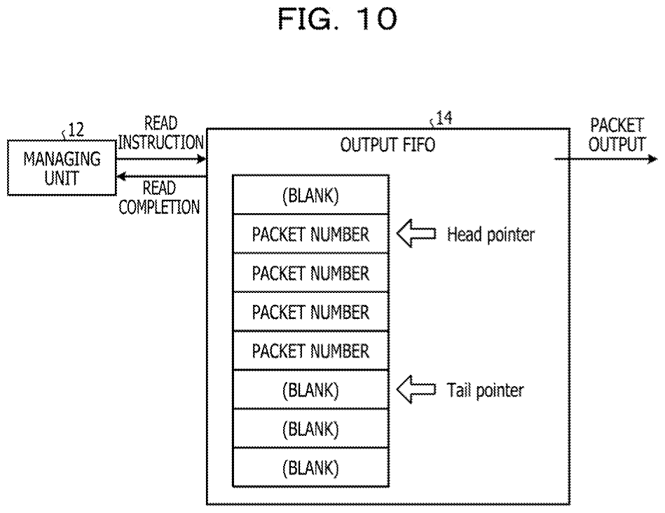

FIG. 10 is an explanatory diagram illustrating an example of the output FIFO 14. The output FIFO 14 illustrated in FIG. 10 sequentially stores packets selected for output, and reads and outputs the head packet according to a read instruction.

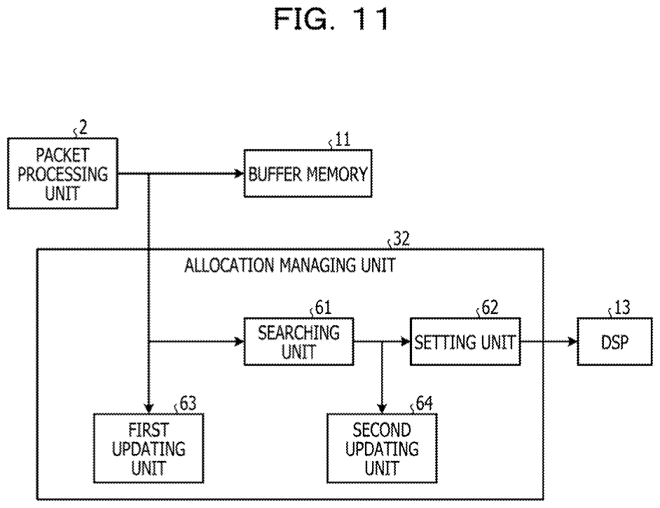

FIG. 11 is an explanatory diagram illustrating an example of the functional configuration of the allocation managing unit 32. The allocation managing unit 32 illustrated in FIG. 11 includes a memory and a processor (not indicated in FIG. 11), and includes a searching unit 61, a setting unit 62, a first updating unit 63, and a second updating unit 64, as functions of the processor. The searching unit 61 refers to the DSP-free management table 43 to search for a free DSP 13. The setting unit 62 sets the setting information of the allocated packet for the free DSP 13 searched for by the searching unit 61. The setting unit 62 loads an output determination program for the free DSP 13 to which the allocated packet is allocated. The output determination program is a program that executes an output determination process of the allocated packet. The first updating unit 63 updates the information of the allocated packet in the packet management table 41. The second updating unit 64 updates the information of the DSP-free management table 43, the DSP allocation management table 44, and the packet allocation management table 42.

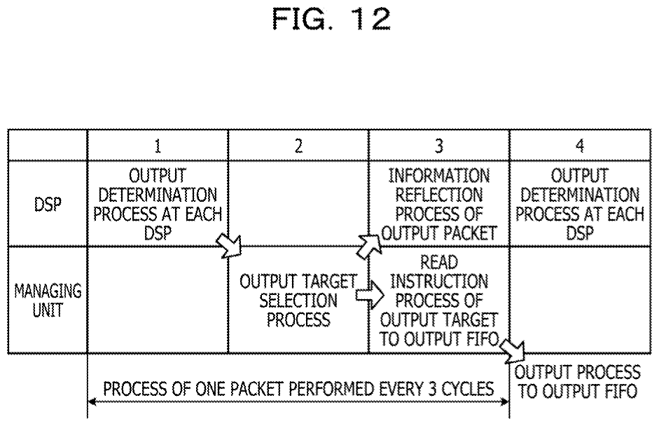

FIG. 12 is an explanatory diagram illustrating an example of the process performed by the DSP 13 and the managing unit 12 for one packet. The DSP 13 and the managing unit 12 need three cycles to process one allocated packet. First, in the first cycle, each DSP 13 executes an output determination process of its own allocated packet. In the second cycle, the managing unit 12 executes a selection process of the output target DSP 13. Further, in the third cycle, the DSP 13 reflects the information of the output packet of the output target DSP 13, and the managing unit 12 executes a process of instructing the output FIFO 14 to read an output packet from the output target DSP 13. As a result, the output FIFO 14 outputs the output packet from the output target DSP 13 according to the read instruction from the managing unit 12.

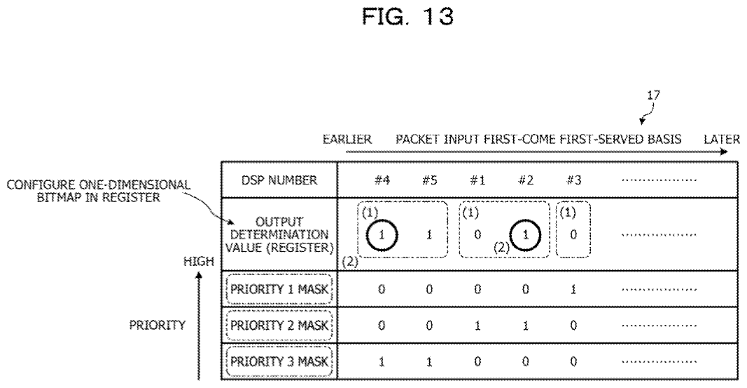

FIG. 13 is an explanatory diagram illustrating an example of a bitmap configuration of the output determination value register 17. For the convenience of description, the priority of a packet is “1” at the highest level, and then, the priority is lowered in the order of “2”→“3”→ . . . . In the example illustrated in FIG. 13, the input first-come first-served basis of input packets is as follows: #4 DSP 13 allocated packet→#5 DSP 13 allocated packet→#1 DSP 13 allocated packet→#2 DSP 13 allocated packet→#3 DSP 13 allocated packet→ . . . . The managing unit 12 masks each input packet for each priority according to the priority of the input packet. The output determination value register 17 masks the output determination values of the allocated packet of the DSP 13 of #4 and #5 with the priority “3,” and masks the output determination values of the allocated packet of the DSP 13 of #1 and #2 with the priority “2.” The output determination value register 17 masks the output determination value of the allocated packet of the DSP 13 of #3 with the priority “1.” Further, the output determination value register 17 manages the output determination values “1” of the allocated packet of the DSP 13 of #4 and #5 and the output determination value “0” of the allocated packet of the DSP 13 of #1. Further, the output determination value register 17 manages the output determination value “1” of the allocated packet of the DSP 13 of #2 and the output determination value “0” of the allocated packet of the DSP 13 of #3. That is, the output determination value register 17 holds the output determination value of each DSP 13 as a one-dimensional bit string on the first-come first-served basis.

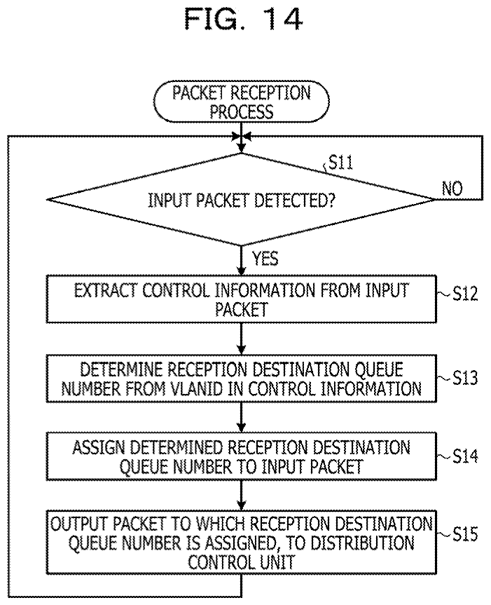

FIG. 14 is a flowchart illustrating an example of the processing operation of the packet processing unit 2 related to the packet reception process. In FIG. 14, the extracting unit 21 in the packet processing unit 2 determines whether or not an input packet has been detected (operation S11). When it is determined that the input packet has been detected (Yes in operation S11), the extracting unit 21 extracts the control information from the input packet (operation S12). The determining unit 23 in the packet processing unit 2 refers to the line setting table 22 to determine a reception destination queue number corresponding to a VLANID in the control information (operation S13). Further, the assigning unit 24 in the packet processing unit 2 assigns the determined reception destination queue number to the input packet (operation S14). Further, the assigning unit 24 outputs the input packet to which the reception destination queue number is assigned, to the distribution control unit 3 (operation S15), and proceeds to operation S11 in order to determine whether or not a new input packet has been detected.

When it is determined that the input packet has been detected, the packet processing unit 2 extracts the VINA ID from the input packet, determines the reception destination queue number corresponding to the extracted VLANID, assigns the determined reception destination queue number to the input packet, and outputs the determined reception destination queue number to the distribution control unit 3. As a result, the packet processing unit 2 may assign a reception destination queue number to the input packet and output it to the distribution control unit 3.

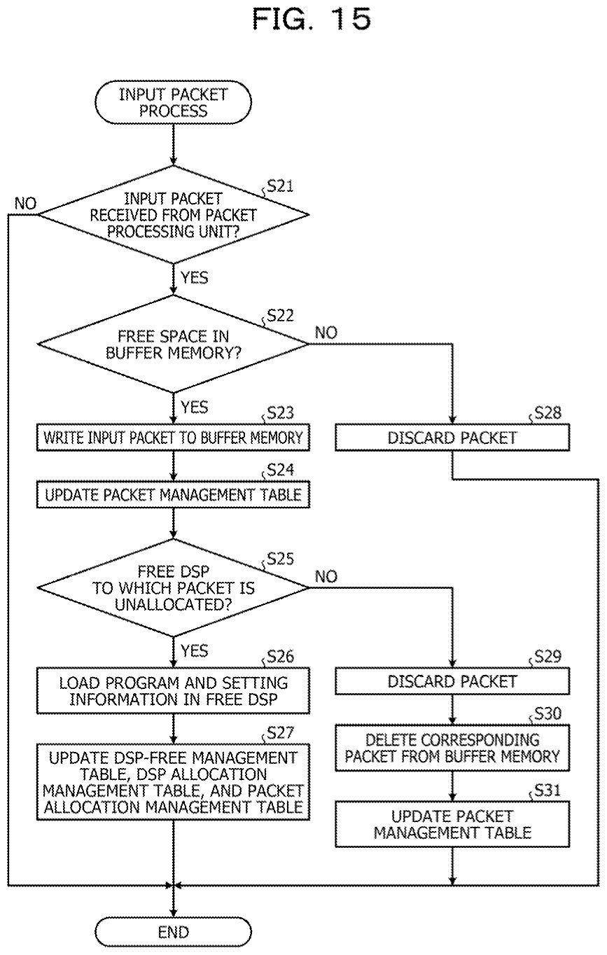

FIG. 15 is a flowchart illustrating an example of the processing operation of the allocation managing unit 32 related to the input packet process. In FIG. 15, the allocation managing unit 32 determines whether or not an input packet has been received from the packet processing unit 2 (operation S21). When it is determined that the input packet has been received (Yes in operation S21), the allocation managing unit 32 determines whether or not there is a free space in the buffer memory 11 (operation S22).

When it is determined that there is a free space in the buffer memory 11 (Yes in operation S22), the allocation managing unit 32 writes the input packet to the buffer memory 11 (operation S23). After writing the input packet to the buffer memory 11, the allocation managing unit 32 updates the contents of the packet management table 41 in order to write a storage address of the input packet to the packet management table 41 in association with a packet number of the input packet (operation S24).

After the packet management table 41 is updated, the searching unit 61 in the allocation managing unit 32 refers to the DSP-free management table 43 to determine whether or not there is a free DSP 13 to which the input packet is unallocated (operation S25). When it is determined that there is a free DSP 13 (Yes in operation S25), the setting unit 62 in the allocation managing unit 32 loads an output determination program and setting information for the free DSP 13 (operation S26). That is, the allocation managing unit 32 allocates the input packet to the free DSP 13. Then, when the allocation of the input packet to the free DSP 13 is completed, the second updating unit 64 in the allocation managing unit 32 updates the contents of the DSP-free management table 43, the DSP allocation management table 44, and the packet allocation management table 42 (operation S27), and then ends the processing operation illustrated in FIG. 15.

When it is determined that the input packet has not been received from the packet processing unit 2 (No in operation S21), the allocation managing unit 32 ends the processing operation illustrated in FIG. 15. When it is determined that there is no space in the buffer memory 11 (No in operation S22), the allocation managing unit 32 discards the input packet (operation S28) and ends the processing operation illustrated in FIG. 15.

Further, when it is determined that there is no free DSP 13 (No in operation S25), the allocation managing unit 32 discards the input packet (operation S29), and deletes the corresponding packet from the buffer memory 11 (operation S30). Further, the first updating unit 63 in the allocation managing unit 32 updates the contents of the packet management table 41 (operation S31) according to the deletion of the corresponding packet, and ends the processing operation illustrated in FIG. 15.

After the input packet is written to the buffer memory 11, the allocation managing unit 32 loads the output determination program and the setting information including the information of the input packet into the free DSP 13. As a result, the DSP 13 executes the output determination process for the allocated packet.

When there is no free DSP 13, the allocation managing unit 32 discards the input packet, and deletes the input packet from the buffer memory 11. Further, when there is no free space in the buffer memory 11, the allocation managing unit 32 discards the input packet. As a result, input packets that have not been processed may be all discarded.

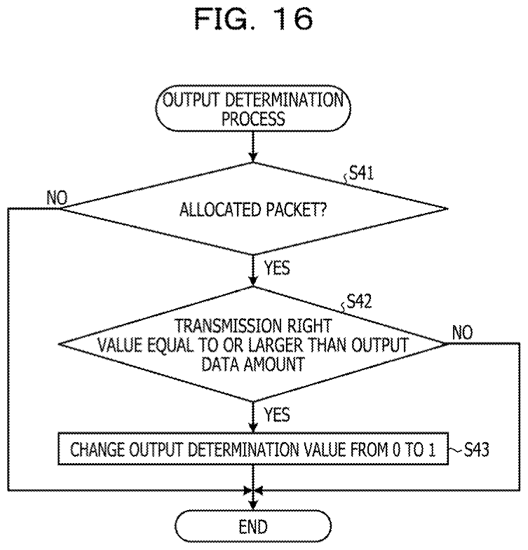

FIG. 16 is a flowchart illustrating an example of the processing operation of the DSP 13 related to the output determination process. In FIG. 16, the DSP 13 determines whether or not there is an allocated packet (operation S41). When it is determined that there is an allocated packet (Yes in operation S41), the DSP 13 determines whether or not the transmission right value of the allocated packet is equal to or larger than the amount of output data of the allocated packet (operation S42).

When it is determined that the transmission right value of the allocated packet is equal to or larger than the amount of output data (Yes in operation S42), the DSP 13 determines that the allocated packet may be output, changes an output determination value from “0” to “1” (operation S43), and ends the processing operation illustrated in FIG. 16. The DSP 13 transmits the output determination value “1” to the managing unit 12. Further, when it is determined that there is no allocated packet (No in operation S41), the DSP 13 ends the processing operation illustrated in FIG. 16. Further, when it is determined that the transmission right value of the allocated packet is not equal to or larger than the amount of output data (No in operation S42), the DSP 13 ends the processing operation illustrated in FIG. 16. The DSP 13 transmits the output determination value “0” to the managing unit 12 while keeping the output determination value “0.”

When there is an allocated packet and when the transmission right value of the allocated packet is equal to or larger than the amount of output data of the allocated packet, the DSP 13 determines that the allocated packet may be output, and sets the output determination value to “1.” As a result, the DSP 13 may notify the managing unit 12 of the output determination value “1” indicating that the allocated packet may be output.

When the transmission right value of the allocated packet is not equal to or larger than the amount of output data of the allocated packet, the DSP 13 determines that the allocated packet may not be output, and sets the output determination value to “0.” As a result, the DSP 13 may notify the managing unit 12 of the output determination value “0” indicating that the allocated packet may not be output.

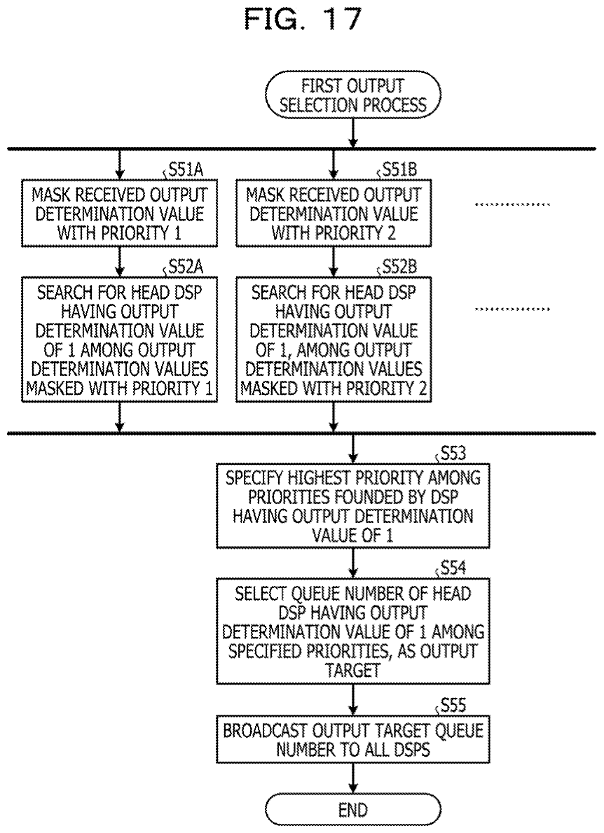

FIG. 17 is a flowchart illustrating an example of the processing operation of the output selecting unit 33 related to the first output selection process. In FIG. 17, when receiving an output determination value from each DSP 13, the output selecting unit 33 identifies a priority of an allocated packet of the DSP 13. Then, when the priority of the allocated packet of the DSP 13 is “1,” the output selecting unit 33 masks output determination values with the priority “1” (operation S51A). The output selecting unit 33 searches for the head DSP 13 in the input first-come first-served basis in which the output determination value is “1,” among the output determination values masked with the priority “1” (operation S52A). The head DSP 13 is a head DSP 13 in the input first-come first-served basis of the packets stored in the buffer memory 11.

When the priority of the allocated packet of the DSP 13 is “2,” the output selecting unit 33 masks the output determination values with the priority “2” (operation S51B). The output selecting unit 33 searches for the head DSP 13 in the input first-come first-served basis in which the output determination value is “1,” among the output determination values masked with the priority “2” (operation S52B). That is, the output selecting unit 33 identifies the priority of the allocated packet of the DSP 13, masks the output determination value for each priority, and searches for the head DSP 13 in the input first-come first-served basis in which the output determination value is “1,” among the output determination values masked for each priority.

When the head DSP 13 is searched in the input first-come first-served basis in which the output determination value is “1” for each priority, the output selecting unit 33 specifies a search result of the highest priority, for example, the priority “1,” from search results of all the priorities (operation S53). The output selecting unit 33 selects an output target queue number for the head DSP 13 having the output determination value of “1,” from the specified search result of the priority (operation S54), broadcasts the output target queue number to all the DSPs 13 (operation S55), and ends the processing operation illustrated in FIG. 17.

The output selecting unit 33 identifies the priority of the allocated packet of the DSP 13, masks the output determination value for each priority, and searches for the head DSP 13 on the first-come first-served basis in which the output determination value is “1,” among the output determination values masked for each priority. When the head DSP 13 having the output determination value of “1” is searched for each priority, the output selecting unit 33 specifies the search result having the highest priority from the search results of all the priorities. The output selecting unit 33 selects the queue number of the head DSP 13 having the output determination value of “1” from the specified search result of the priority as the output target queue number, and notifies all the DSPs 13 of the output target queue number. As a result, each DSP 13 may recognize the output target queue number.

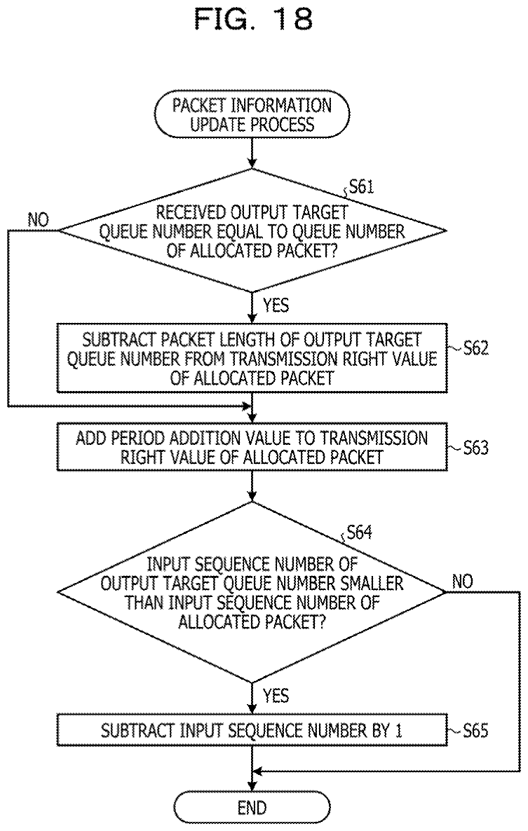

FIG. 18 is a flowchart illustrating an example of the processing operation of the DSP 13 related to the packet information update process. In FIG. 18, the DSP 13 determines whether or not an output target queue number received from the output selecting unit 33 is equal to a queue number of an allocated packet (operation S61). When it is determined that the output target queue number is equal to the queue number of the allocated packet (Yes in operation S61), the DSP 13 updates the transmission right value by subtracting the packet length of the output target queue number from the transmission right value of the allocated packet (operation S62).

The DSP 13 updates the transmission right value by adding a period addition value to the transmission right value of the allocated packet (operation S63). The period addition value is the amount of output data to be added for each update cycle of the transmission right value. The contract speed differs depending on the contract contents for each reception destination queue number. The DSP 13 determines whether or not an input sequence number of the output target queue number is smaller than an input sequence number of the held allocated packet (operation S64). When it is determined that the input sequence number of the output target queue number is smaller than the input sequence number of the held allocated packet (Yes in operation S64), the DSP 13 subtracts the input sequence number by “1” to update the input sequence number (operation S65), and ends the processing operation illustrated in FIG. 18.

When it is determined that the output target queue number is not equal to the queue number of the allocated packet (No in operation S6), the DSP 13 proceeds to operation S63 in order to update the transmission right value by adding the period addition value to the transmission right value of the allocated packet. Further, when it is determined that the input sequence number of the output target queue number is not smaller than the input sequence number of the held allocated packet (No in operation S64), the DSP 13 ends the processing operation illustrated in FIG. 18.

When the output target queue number is equal to the queue number of the allocated packet, each DSP 13 updates the transmission right value by subtracting the packet length of the output target queue number from the transmission right value of the allocated packet. Further, the DPS 13 updates the transmission right value by adding the period addition value to the transmission right value of the allocated packet, and updates the input sequence number by subtracting the input sequence number by “1” when the input sequence number of the out target queue number is smaller than the input sequence number of the held allocated packet. That is, each DSP 13 updates the transmission right value and the input sequence number of the allocated packet according to the output of the allocated packet. Since the DSP 13 is allocated to each input packet, it is possible to avoid a situation in which the update cycle at which the period addition value of the transmission right value is updated becomes long, even when the queue number increases.

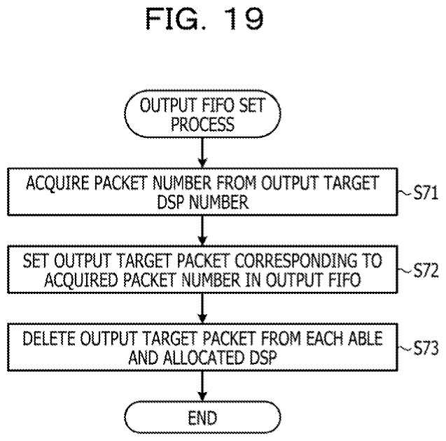

FIG. 19 is a flowchart illustrating an example of the processing operation of the allocation managing unit 32 related to the output FIFO set process. In FIG. 19, the allocation managing unit 32 acquires a packet number that identifies an allocated packet, from a DSP number corresponding to the output target queue number (operation S71). The allocation managing unit 32 reads the output target packet corresponding to the acquired packet number from the buffer memory 11, and sets the output target packet in the output FIFO 14 (operation S72).

The allocation managing unit 32 deletes information of the output target packet from each management table and an allocated DSP 13 (operation S73), and ends the processing operation illustrated in FIG. 19.

The allocation managing unit 32 acquires the packet number that identifies the allocated packet from the DSP number corresponding to the output target queue number, reads the output target packet corresponding to the acquired packet number from the buffer memory 11, and sets the output target packet in the output FIFO 14. Further, the allocation managing unit 32 deletes the information of the output target packet from each management table and the allocated DSP 13. As a result, when the allocated packet corresponding to the output target queue number is set in the output FIFO 14, the information of the output target allocated packet may be deleted from the allocated DSP 13.

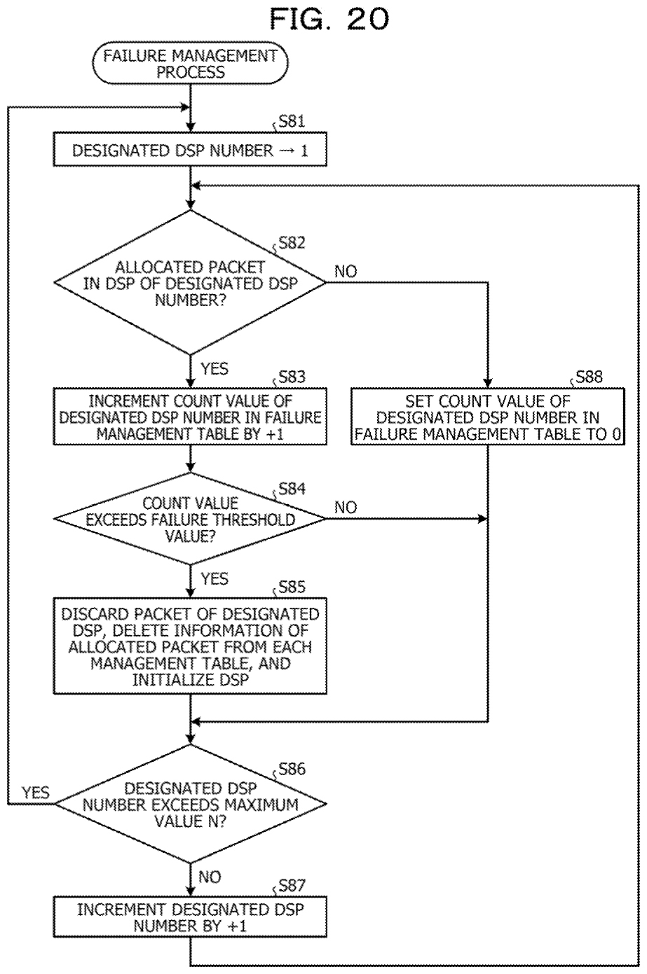

FIG. 20 is a flowchart illustrating an example of the processing operation of the allocation managing unit 32 related to the failure monitoring process. In FIG. 20, the allocation managing unit 32 designates a DSP number “1” (operation S81), and refers to the DSP allocation management table 44 to determine whether or not there is an allocated packet in the DSP 13 of the designated DSP number (operation S82). When it is determined that there is an allocated packet in the DSP 13 of the designated DSP number (Yes in operation S82), the allocation managing unit 32 increments the count value of the designated DSP number in the failure management table 45 by +1 (operation S83).

After incrementing the count value by +1, the allocation managing unit 32 determines whether or not the count value exceeds a failure threshold value (operation S84). When it is determined that the count value exceeds the failure threshold value (Yes in operation S84), the allocation managing unit 32 discards the allocated packet corresponding to the designated DSP number from the buffer memory 11. Further, the allocation managing unit 32 deletes packet information and DSP information corresponding to the designated DSP number from each table and initializes setting information of the designated DSP 13 (operation S85).

In operation S85, each table is, for example, the packet management table 41, the packet allocation management table 42, the DSP-free management table 43, or the DSP allocation management table 44. That is, the allocation managing unit 32 deletes the packet number and the storage address of the allocated packet of the designated DSP number from the packet management table 41. Further, the allocation managing unit 32 deletes the designated DSP number and the packet number of the allocated packet from the packet allocation management table 42 and the DSP allocation management table 44. Further, since the designated DSP number becomes a free DSP 13 according to the deletion of the designated DSP number and the packet number, the allocation managing unit 32 registers the free DSP number of the free DSP 13 in the DSP-free management table 43.

The allocation managing unit 32 determines whether or not the designated DSP number exceeds a maximum value N (operation S86). The maximum value N is the number of all DSPs 13. When it is determined that the designated DSP number does not exceed the maximum value N (No in operation S86), the allocation managing unit 32 increments the designated DSP number by +1 (operation S87), and proceeds to operation S82 in order to determine whether or not there is an allocated packet in the DSP 13 of the designated DSP number.

When it is determined that the designated DSP number exceeds the maximum value N (Yes in operation S86), the allocation managing unit 32 proceeds to operation S81 in order to designate the designated DSP number “1.” When it is determined that the count value does not exceed the failure threshold value (No in operation S84), the allocation managing unit 32 proceeds to operation S86 in order to determine whether or not the designated DSP number exceeds the maximum value N.

Further, when it is determined that there is no allocated packet in the DSP 13 of the designated DSP number (No in operation S82), the allocation managing unit 32 sets the count value of the designated DSP number in the failure management table 45 to “0” (operation S88), and ends the processing operation illustrated in FIG. 20.

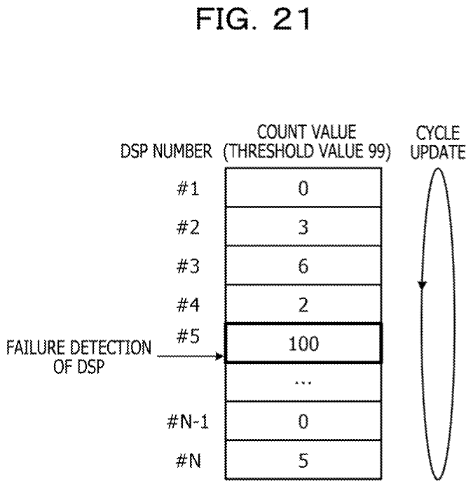

FIG. 21 is an explanatory diagram illustrating an example of the failure management table 45 at the time of DSP failure detection. For the convenience of description, for DSP numbers #1 to #N, it is assumed that the failure threshold value is “99.” Further, although the failure threshold value is “99,” it is not limited to “99” but may be set as appropriate. The allocation managing unit 32 sets the counting operation of the packet retention count value of the DSP 13 from the DSP number #1 to the DSP number #N as one cycle, and after the completion of the packet retention counting operation of the DSP number #N, again proceeds to the packet retention counting operation of the DSP number #1.

The allocation managing unit 32 refers to the failure management table 45 to recognize, for example, the count value of the DSP number #1 as “0,” the count value of the DSP number #2 as “0,” and the count value of the DSP number #5 as “100.” When the count value of the DSP number #5 is “100,” the allocation managing unit 32 determines that the count value exceeds the failure threshold value, to determine that the DSP 13 corresponding to the DSP number #5 has a failure.

The allocation managing unit 32 determines whether or not there is an allocated packet for each DSP number, increments the count value of the DSP number by +1 when there is an allocated packet, and determines that the DSP 13 of the corresponding DSP number has a failure when the count value exceeds the failure threshold value. As a result, the allocation managing unit 32 may refer to the count value for each DSP number to determine that the DSP 13 in which the allocated packet is retained during a period when the count value exceeds the failure threshold value has the failure.

Since the allocation managing unit 32 discards the allocated packet of the DSP 13 having whose count value exceeds the failure threshold value, it is possible to avoid the retention of the allocated packet.

When an input packet is detected, the packet transmission device 1 of the present embodiment allocates a free DSP 13 for each input packet. Each DSP 13 manages the transmission right value of the allocated packet, executes the output determination process of the allocated packet based on the transmission right value, and notifies the managing unit 12 of an output determination value. Further, the packet managing unit selects an output target DSP 13 based on the output determination value of each DSP 13.

When a packet is detected, the managing unit 12 in the packet transmission device 1 allocates the detected packet to a free DSP 13 in a plurality of DSPs 13. Further, the DSP 13 determines whether or not the transmission right value of the allocated packet is equal to or larger than the amount of output data, and notifies the managing unit 12 of the output determination result. The managing unit 12 selects an output target DSP 13 based on the output determination result of each DSP 13, and sets a packet allocated to the selected output target DSP 13 in the output FIFO 14. As a result, packet management and output determination may be distributed and controlled in each DSP 13 without requiring centralized control of the scheduler of the comparative example. Therefore, even when the queue number increases, it is possible to suppress the decrease in throughput of packet transmission by eliminating the waiting time for the update cycle for updating the transmission right value and the search time for the presence or absence of accumulation. That is, it is possible to cope with the increase in connection destinations.

Each DSP 13 manages the transmission right value of the allocated packet, and executes the output determination of the allocated packet based on the transmission right value. As a result, even when the queue number increases, it is possible to perform a low-load packet transmission process by eliminating a need for a scheduler of centralized control as the processing time is constant with the distributed processing of the DSP 13 and the load of the unit of DSP 13 is made almost constant.

The managing unit 12 sorts the output determination result of each DSP 13 according to the priority of the corresponding packet, and searches for the head DSP 13 from DSPs 13 having the output determination value “1” for each priority on the first-come first-served basis. Further, the managing unit 12 selects the DSP 13 having the highest priority as the output target DSP 13 from the search result for each priority. As a result, the output target DSP 13 may be selected on the first-come first-served basis from a DSP 13 having a higher priority.

The managing unit 12 selects the highest priority DSP 13 as the output target DSP 13, and notifies each DSP 13 of the queue number of a packet allocated to the selected output target DSP 13. As a result, each DSP 13 may recognize the queue number of the packet allocated to the output target DSP 13.

Each DSP 13 receives the queue number of the packet allocated to an output target processor, from the managing unit 12, and when a corresponding queue number is the queue number of the allocated packet, updates the transmission right value by subtracting the packet length corresponding to the corresponding queue number from the transmission right value. As a result, the output target DSP 13 may set the allocated packet in the output FIFO and output it, and may update the transmission right value according to the output of the allocated packet.

The managing unit 12 sets an output determination program for determining whether or not the transmission right value is equal to or larger than the amount of output data, in the free DSP 13 to which the detected packet is allocated. As a result, when the input packet is allocated, the DSP 13 may set the output determination program and execute the output determination process.

The managing unit 12 periodically monitors whether there is a packet allocated to each DSP 13, increments the count value when there is a packet, and resets the count value when there is no packet. Further, the managing unit 12 determines that the DSP 13 has a failure when the count value exceeds the failure threshold value. As a result, the managing unit 12 may recognize the failure of the DSP 13.

Since the managing unit 12 does not perform search or update of all DSPs 13, the load is significantly smaller than that of the scheduler in the comparative example. As a result, a need for the scheduler that performs a centralized control is eliminated, which may result in reduction in the performance level of parts (cost saving is possible). Moreover, the output FIFO 14 is used for guaranteeing the input order, which does not use a special processing. Further, in recent years, since the number of DSPs with built-in FPGA tends to increase, device costs may be reduced.

Descriptions have been made on a case where the output determination value register 17 of the first embodiment masks the output determination value of the allocated packet of each DSP 13 for each priority and holds the output determination value of each DSP 13 as a one-dimensional bit string on the first-come first-served basis. However, the output determination value of the allocated packet of the DSP 13 may not be masked for each priority, and may be changed as appropriate. Therefore, an embodiment thereof will be described as a packet transmission device of a second embodiment. The same configurations as those of the packet transmission device 1 of the first embodiment will be denoted by the same reference numerals, and descriptions of the overlapping configurations and operations will be omitted.

### Second Embodiment

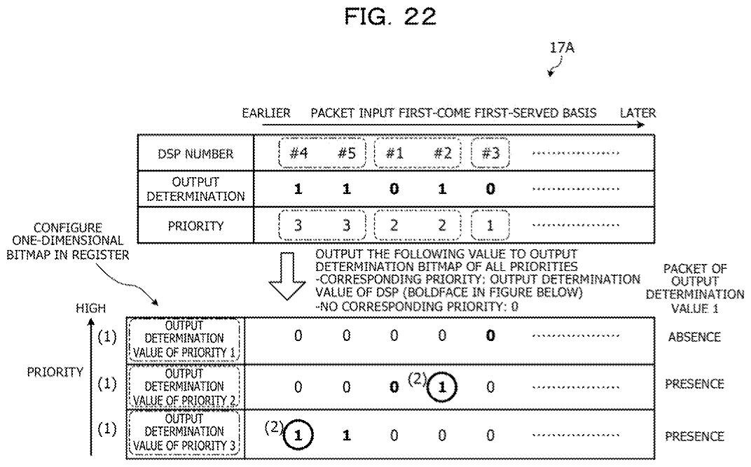

FIG. 22 is an explanatory diagram illustrating an example of a bitmap configuration of an output determination value register 17A according to the second embodiment. For the convenience of description, the priority of an allocated packet is “1” at the highest level, and then the priority is lowered in the order of “2”→“3”→ . . . . In the example illustrated in FIG. 22, the input first-come first-served basis of allocated packets is as follows: #4 DSP 13 allocated packet→#5 DSP 13 allocated packet→#1 DSP 13 allocated packet→#2 DSP 13 allocated packet→#3 DSP 13 allocated packet→ . . . . The output selecting unit 33 stores the output determination value of an input packet for each priority in the output determination value register 17A, as a one-dimensional bit string. That is, the output determination value register 17A holds the output determination value of each DSP 13 for each priority as a one-dimensional bit string on the first-come first-served basis.

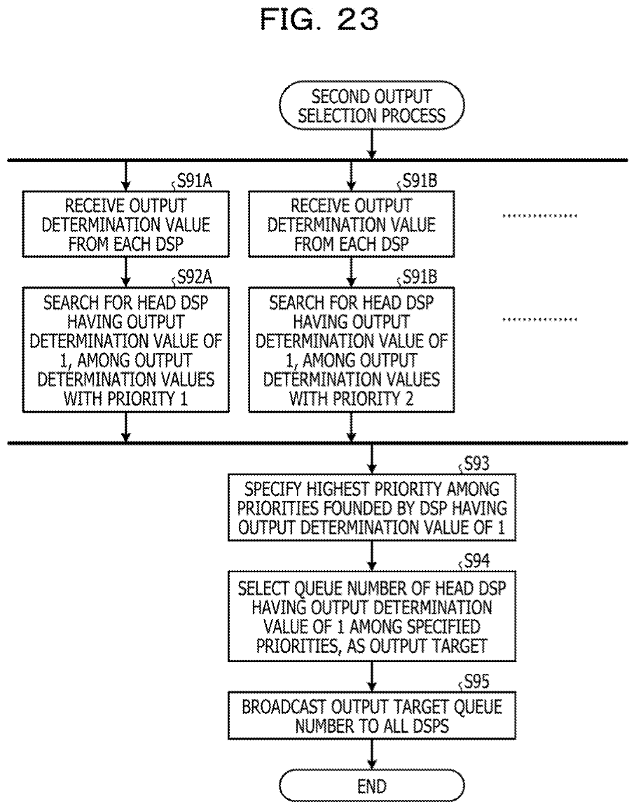

FIG. 23 is a flowchart illustrating an example of the processing operation of the output selecting unit 33 related to the second output selection process of the second embodiment. In FIG. 23, when the output determination value is received from each DSP 13, the output selecting unit 33 identifies the priority of an allocated packet of the DSP 13. Then, the output selecting unit 33 receives the output determination value of the DSP 13 (operation S91A). When the output determination value of the DSP 13 is received, the output selecting unit 33 searches for the head DSP 13 among output determination values of the allocated packet having the priority “1” in the input first-come first-served basis in which the output determination value is “1” (operation S92A). Further, the output selecting unit 33 receives the output determination value of the DSP 13 (operation S91B). When the output determination value of the DSP 13 is received, the output selecting unit 33 searches for the head DSP 13 among the output determination values of the allocated packet having the priority “2” in the input first-come first-served basis in which the output determination value is “1” (operation S92B). The priority of the allocated packet is not limited to “1” and “2,” and may be changed as appropriate. That is, the output selecting unit 33 searches for the head DSP 13 among the output determination values of the allocated packet for each priority in the input first-come first-served basis in which the output determination value is “1.”

When the head DSP 13 is searched in the input first-come first-served basis in which the output determination value is “1” for each priority, the output selecting unit 33 specifies a search result of the highest priority, for example, the priority “1,” from search results of all the priorities (operation S93). The output selecting unit 33 selects an output target queue number for the head DSP 13 having the output determination value of “1,” from the specified search result of the priority (operation S94), broadcasts the output target queue number to all the DSPs 13 (operation S95), and ends the processing operation illustrated in FIG. 23.

The output selecting unit 33 identifies the priority of the allocated packet of the DSP 13, and searches for the head DSP 13 on the first-come first-served basis in which the output determination value is “1,” among the output determination values for each priority. When the head DSP 13 having the output determination value of “1” is searched for each priority, the output selecting unit 33 specifies the search result having the highest priority from the search results of all the priorities. The output selecting unit 33 selects the queue number of the head DSP 13 having the output determination value of “1” from the specified search result of the priority as the output target queue number, and notifies all the DSPs 13 of the output target queue number. As a result, each DSP 13 may recognize the output target queue number.

The managing unit 12 in the packet transmission device 1 of the second embodiment acquires the output determination result of each DSP 13, stores the output determination value for each priority in the output determination value register 17A, and searches for the head DSP 13 on the first-come first-served basis from DSPs 13 having the output determination value “1” for each priority. Further, the managing unit 12 selects the highest priority DSP as the output target DSP 13 from the search result for each priority. As a result, the output target DSP 13 may be selected on the first-come first-served basis from a DSP 13 having a higher priority.

Although the DSP 13 has been described as a processor of the present embodiment, the processor is not limited to the DSP 13, but may be, for example, a processor such as a central processing unit (CPU), a micro processing unit (MPU), or a micro controller unit (MCU), and may be changed as appropriate.

For the convenience of description, the distribution control unit 3 has described with the packet management memory 15, the resource management memory 16, the output determination value register 17, and the failure management memory 18, which are separated. However, the distribution control unit 3 may employ a single memory and may be changed as appropriate. Further, although the packet number is the same as the storage address number for storing packets in the buffer memory 11, the packet number may be a number for identifying the packets and may be changed as appropriate.

Further, although the single managing unit 12 has been described, a plurality of managing units 12 may be provided for distributed control in consideration of the processing load of the managing unit 12 and may be changed as appropriate.

Further, each component of each illustrated device may not necessarily be configured physically as illustrated. That is, specific forms of distribution or integration of the respective devices are not limited to those illustrated, and all or a portion of the devices may be configured to be functionally or physically distributed or integrated in arbitrary units according to, for example, various loads or usage conditions.

Furthermore, all or an arbitrary portion of the various processing functions performed by the respective devices may be executed on a CPU (or a microcomputer such as a MPU or a MCU). In addition, all or an arbitrary portion of the various processing functions may be executed on a program analyzed and executed by a CPU (or a microcomputer such as a MPU or a MCU) or on hardware by a wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet transmission device comprising:
a memory; and
a first processor coupled to the memory and configured to:
allocate a packet to a free processor in a plurality of second processors;
acquire output determination results of determining whether or not a transmission right value of the allocated packet is equal to or larger than an amount of output data, from the second processors;
select an output target processor from the second processors, based on the output determination results of each of the second processors; and
set the packet allocated to the selected output target processor to output by a first-in first-out manner.

2. The packet transmission device according to claim 1,
wherein the first processor is configured to:
sort the output determination results according to a priority of the packet;
search for a head processor on a first-come first-served basis from the second processors including the output determination results of output enable for each priority; and
select the second processor including the highest priority as the output target processor, based on a search result for each priority.

3. The packet transmission device according to claim 1,
wherein the first processor is configured to:
acquire the output determination results of each of the second processors and store an output determination value for each priority;
search for a head processor in the second processors on a first-come first-served basis from the second processors including the output determination results of output enable for each priority; and
select the second processor including a highest priority as the output target processor, based on a search result for each priority.

4. The packet transmission device according to claim 2,
wherein the first processor is configured to notify each of the second processors of a queue number of the packet allocated to the selected output target processor.

5. The packet transmission device according to claim 4,
wherein each of the second processors is configured to:
receive the queue number, and
update the transmission right value by subtracting a packet length corresponding to the queue number from the transmission right value, when the queue number is a queue number of the allocated packet.

6. The packet transmission device according to claim 1,
wherein the first processor is configured to set, in the free processor, an output determination program that determines whether or not the transmission right value is equal to or larger than the amount of output data.

7. The packet transmission device according to claim 1,
wherein the first processor is configured to:
periodically monitor whether there is a packet allocated for each of the second processors,
increment a count value when there is the packet, and reset the count value when there is no packet; and
determine that a second processor of the second processors has a failure when the count value exceeds a failure threshold value.

8. A packet transmission method that causes a first processor to execute a procedure, the procedure comprising:
allocating a packet to a free processor in a plurality of second processors;
acquiring output determination results of determining whether or not a transmission right value of the allocated packet is equal to or larger than an amount of output data, from the second processors;
selecting an output target processor from the second processors, based on the output determination results of each of the second processors; and
setting the packet allocated to the selected output target processor to output by a first-in first-out manner.
